(19) United States
(12) Patent Application Publication
(10) Pub. No.: US 2026/0124693 A1
(43) Pub. Date: May 7, 2026

(54) Deliberate Defect Introduction in Additive Manufacturing

(71) Applicant: Relativity Space, Inc., Long Beach, CA (US)

(72) Inventors: David Leiphon, Long Beach, CA (US); Scott Stanfield, Long Beach, CA (US); Oojas Salunke, Long Beach, CA (US); Erik Richman, Long Beach, CA (US); Noah Giles, Long Beach, CA (US); Scott Mungo, Long Beach, CA (US)

(73) Assignee: Relativity Space, Inc., Long Beach, CA (US)

(21) Appl. No.: 19/379,451

(22) Filed: Nov. 4, 2025

Related U.S. Application Data
(60) Provisional application No. 63/716,673, filed on Nov. 5, 2024.

(51) Int. Cl. B23K 9/04; B23K 9/095; B23K 9/173; B23K 9/32; B33Y 30/00; B33Y 40/00

(52) U.S. Cl. CPC B23K 9/042; B23K 9/0956; B23K 9/173; B23K 9/325; B33Y 30/00; B33Y 40/00

(57) ABSTRACT

Systems and methods for deliberate defect introduction in additive manufacturing are disclosed. In one embodiment, a robotic additive manufacturing system includes an additive manufacturing robot, the additive manufacturing robot including a robotic arm, a welder system mounted to the robotic arm and including a welding tip configured to deposit a consumable electrode wire onto an additively-manufactured article, a signals data storage system configured to receive from the welder system one or more signals indicative of a voltage and a current and to store the signals as a time series, a defect introduction system configured to receive an interrupt signal and to trigger a release mechanism configured to disrupt shielding gas around the welding tip based upon the interrupt signal, and a clock configured to provide a clock signal to the signals data storage system and the defect introduction system.

### CROSS-REFERENCE TO RELATED APPLICATIONS

The current application claims the benefit of and priority under 35 U.S.C. § 119(e) to U.S. Provisional Patent Application No. 63/716,673 entitled “Deliberate Defect Introduction in Additive Manufacturing” filed Nov. 5, 2024. The disclosure of U.S. Provisional Patent Application No. 63/716,673 is hereby incorporated by reference in its entirety for all purposes.

### FIELD OF THE INVENTION

The present invention relates generally to additive manufacturing systems, and more specifically to intentionally introducing defects while capturing contextual data during additive manufacturing of an article.

### BACKGROUND

Additive manufacturing is a process by which an article is manufactured by adding one layer of material on top of another in a sequence that results in a complete article being built. This method of manufacturing is commonly referred to as three dimensional or 3D printing and can be performed with different materials, including plastic and metal. Wire arc additive manufacturing (WAAM) is a production process used to 3D print or repair metal articles using a metal wire feedstock and an electric arc.

WAAM typically involves using an energy source to create an electric arc that forms a weld pool, and feeding a metal wire into the weld pool by way of a printing head, such as a conventional or modified welding gun. An electric current carried by the feed wire is used to create the electric arc that forms the weld pool. The printing head and subsequently the weld pool can be moved. As the printing head and the welding pool moves, the trailing edge of the pool cools and solidifies. Through this process of gradually moving the printing head along a path, a fully solidified article is formed.

The process by which material is deposited can be controlled by the use of shielding gas around the feeding material. The shielding gas can help to make a better weld pool for an overall better part. The shielding gas can protect the weld pool from reactive gases and moisture.

### SUMMARY OF THE INVENTION

Systems and methods for deliberate defect introduction in additive manufacturing are disclosed. In one embodiment, a robotic additive manufacturing system includes an additive manufacturing robot, the additive manufacturing robot including a robotic arm, a welder system mounted to the robotic arm and including a welding tip configured to deposit a consumable electrode wire onto an additively-manufactured article, a signals data storage system configured to receive from the welder system one or more signals indicative of a voltage and a current and to store the signals as a time series, a defect introduction system configured to receive an interrupt signal and to trigger a release mechanism configured to disrupt shielding gas around the welding tip based upon the interrupt signal, and a clock configured to provide a clock signal to the signals data storage system and the defect introduction system.

In additional embodiments of the invention, the defect introduction system also includes an air compressor and a nozzle, the release mechanism includes at least one pneumatic solenoid, the air compressor is configured to provide compressed air through the solenoid and to the nozzle, the release system is configured to be triggered based upon the interrupt signal to open a path for the compressed air to the nozzle, and the nozzle is positioned near the welding tip.

In more embodiments of the invention, the release system comprises two pneumatic solenoids that are configured to be independently and alternately actuated.

In still more embodiments of the invention, the at least one pneumatic solenoid is configured to be electrically driven closed.

In even more embodiments of the invention, the defect introduction system is configured to receive parameters indicating a position of the nozzle.

In further embodiments of the invention, the defect introduction system is configured to inject contaminants into the shielding gas.

In still further embodiments of the invention, the defect introduction system is configured to determine and apply offsets to the interrupt signal when triggering the release mechanism.

In additional embodiments of the invention, the defect introduction system is configured to receive data from a sensor to determine offsets.

In more embodiments of the invention, the signals data storage system includes an oscilloscope.

In still more embodiments of the invention, the defect introduction system also includes at least one liquid tank and a nozzle and is configured to release liquid from the at least one liquid tank through the nozzle based upon the interrupt signal.

In even more embodiments of the invention, a method for introducing defects during an additive manufacturing process includes capturing a data signal including voltage and current information while a welding system having a welding tip performs a wire arc additive manufacturing (WAAM) process to deposit metal onto an article, capturing frames of video of the welding system while it performs the WAAM process, associating timestamps with the voltage and current information and with frames of video as they are being captured, receiving an interrupt signal at a defect introduction system configured to trigger a release mechanism that disrupts shielding gas around the welding tip, triggering the release mechanism over a time duration based on the interrupt signal, correlating at least some voltage and current information to at least some of the frames of video using the timestamps at times where the frames of video show irregularities in the WAAM process.

In further embodiments of the invention, the method also includes providing voltage and current information to train a machine learning model to determine whether defects occur based on the voltage and current information.

In still further embodiments of the invention, the release mechanism comprises at least one pneumatic solenoid, and where the defect introduction system further comprises an air compressor configured to provide compressed air through the solenoid and to the nozzle.

In additional embodiments of the invention, the release system comprises two pneumatic solenoids in parallel that are configured to be independently and alternately actuated.

In more embodiments of the invention, the method also includes generating a digital twin from the voltage and current information that visualizes the article and locations of potential defects in the article.

In still more embodiments of the invention, a method includes capturing a data signal including information about an additive manufacturing process while an additive manufacturing system deposits an additive feedstock onto an article being additively manufactured, associating timestamps with the information about the additive manufacturing process as it is being captured, receiving an interrupt signal at a defect introduction system configured to trigger a mechanism that disrupts the additive manufacturing process, associating at least one timestamp with the interrupt signal, correlating at least some of the information about the additive manufacturing process to the interrupt signal using the timestamps.

In even more embodiments of the invention, the additive feedstock being deposited is a consumable electrode wire.

In further embodiments of the invention, the defect introduction system is configured to disrupt the additive manufacturing process by disrupting shielding gas around the additive feedstock being deposited.

In still further embodiments of the invention, the defect introduction system is configured disrupt the additive manufacturing process by injecting a contaminant into the shielding gas.

In additional embodiments of the invention, the defect introduction system is configured to disrupt the additive manufacturing process by applying a contaminant to the additive feedstock being deposited.

In more embodiments of the invention, the data signal comprises at least one of voltage or current information.

In still more embodiments of the invention, the additive feedstock being deposited is a cold spray powder.

### BRIEF DESCRIPTION OF THE DRAWINGS

The description and claims will be more fully understood with reference to the following figures and data graphs, which are presented as example embodiments of the invention and should not be construed as a complete recitation of the scope of the invention.

FIGS. 1A-1C illustrate plots of voltage vs. current of a welding gun in accordance with embodiments of the invention.

FIGS. 2A and 2B show an image of a pore detected in a WAAM constructed article in accordance with embodiments of the invention.

FIG. 3 conceptually illustrates a WAAM system in accordance with embodiments of the invention.

FIG. 4A conceptually illustrates a defect introduction system in accordance with embodiments of the invention.

FIG. 4B illustrates a circuit diagram for operating solenoids in accordance with embodiments of the invention.

FIG. 5 is a photograph showing a defect introduction system having two solenoids in parallel in accordance with embodiments of the invention.

FIG. 6 s a photograph showing a nozzle held in place near a welding gun with a clamp.

FIG. 7 illustrates a potential user interface screen in accordance with embodiments of the invention.

FIG. 8 illustrates a process for introducing defects in accordance with embodiments of the invention.

### DETAILED DESCRIPTION

Turning now to the drawings, systems and methods for deliberate defect introduction in articles formed by additive manufacturing in accordance with various embodiments of the invention are illustrated. Additive manufacturing techniques, such as (but not limited to) Wire Arc Additive Manufacturing (WAAM), can have various complications not present in traditional manufacturing processes. For example, there are many parameters that are involved in WAAM. Computer control of various parameters automatically with minimal or zero human intervention can improve WAAM manufacturing processes. However, incorrect or suboptimal selection of the parameters controlling a WAAM manufacturing process can result in undesirable porosity or other defects that can compromise manufactured articles, by for example impairing the stability of the process. The occurrence of defects can be unpredictable and unavoidable even with considerable effort in controlling parameters of the manufacturing process, to maintain its stability or otherwise optimize its progress. Accordingly, systems and methods in accordance with many embodiments of the invention can deliberately introduce defects in an article manufactured by a WAAM system, for example by deliberately impairing the stability of the manufacturing process, in a monitored way in order to collect contextual data around the occurrence of each defect. The data can give insights into how defects arise and how they can be predicted from changes in data patterns that deviate in ways that indicate that a defect occurred. The collected data can include parameters of the WAAM system at points in time when the defects are introduced. The defects can be detected and their characteristics also obtained as part of the data. By time stamping the WAAM system parameters, and relating these to the defects, a time series can be constructed so that the defects can be correlated with the parameters that caused them. Defects, as used here, can refer to any type of perturbations to the material deposited by WAAM whether they detract from the material integrity or improve properties of the material.

The defects can be caused by any of a number of deliberate disruptions in accordance with embodiments of the invention, such as, but not limited to, interrupting the flow of shielding gas around the welding gun tip and/or introducing contaminants into the gas stream before or after the stream leaves the welding gun. Deliberate disruptions can further include interrupting the flow of feedstock (e.g., metal wire) through the welding gun and/or introducing contaminants into or upon the feedstock before or after the feedstock leaves the welding gun. Deliberate disruptions can further include interrupting the flow of energy (e.g., voltage, current, heat) through the welding gun and/or introducing additional energy (e.g., voltage, current, heat) into or upon the feedstock before or after the feedstock leaves the welding gun. Deliberate disruptions can further include introducing contaminants into or upon the article being manufactured ahead of the welding gun. In additional embodiments of the invention, air or a liquid can be introduced to interrupt the flow of shielding gas. Deliberate disruptions that cause defects are not limited to those introduced here.

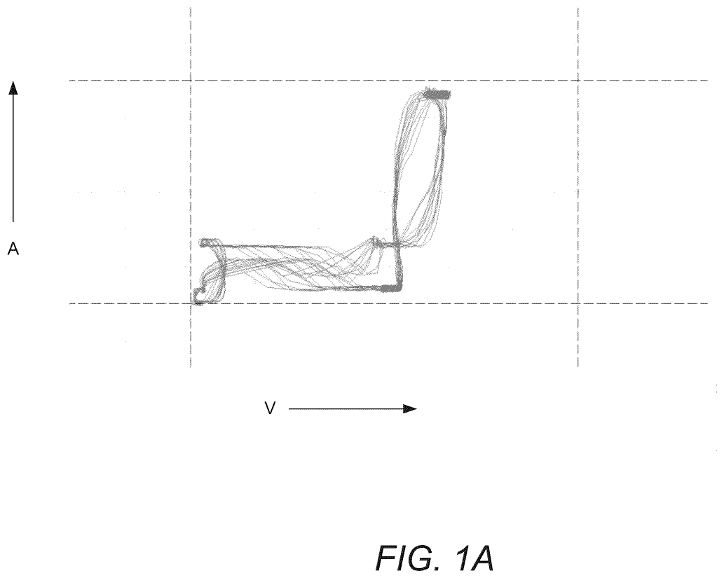

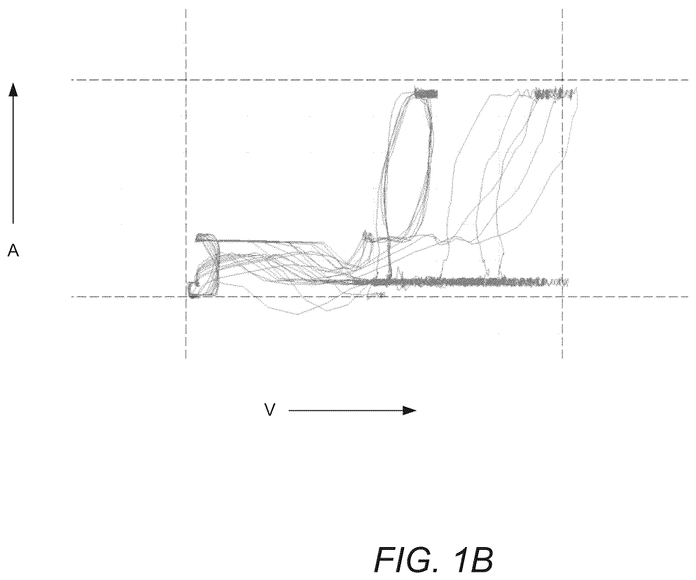

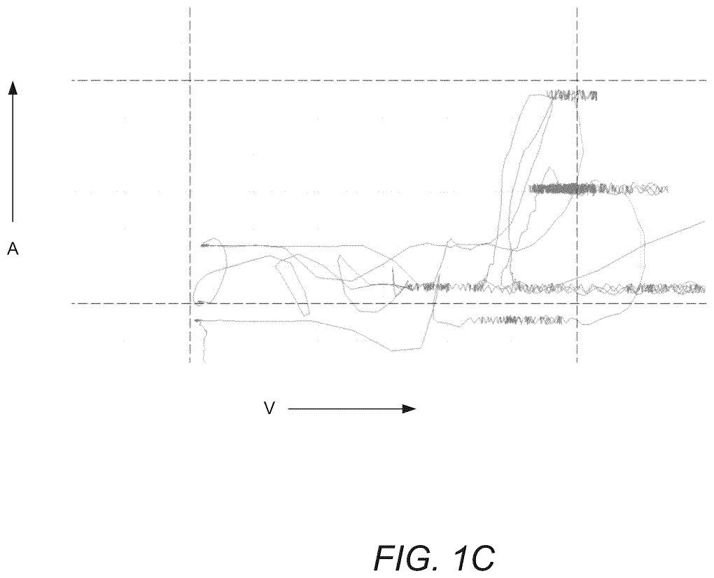

There are several parameters that may indicate stability of the manufacturing process and the possibility of defects, including welding parameters such as voltage, current, wire feed speed, contact tip to weld pool distance, weld fume extraction pressure and flow rates, and shielding gas flow rates, for example. Environmental conditions such as ambient temperature and humidity, weld substrate temperature, and ambient air movement may also be indicative. Additionally, audio emanating from the welding process, vibration and other uncommanded motion in the robot and welding gun hardware, as well as visible spectrum and infrared video can be sources of indicative information. Two prominent parameters that can affect the proper formation of a weld by the welding gun, or the proper maintenance of a welding pool, are voltage and current that is passing through the welding gun or that is manifesting in the electric arc at of the tip of the welding gun. An example plot of voltage versus current over time in a normal operation of a WAAM system is shown in FIG. 1A. The pattern mostly repeats and overlaps over time. The plot in FIG. 1B shows the beginning of a disruption to the welding process in accordance with embodiments of the invention, where the current and voltage plotted by the line depart from the previously seen pattern. FIG. 1C shows a plot further along the disruption where the pattern has been lost and the current and voltage vary widely over time, even regularly violating suitable threshold levels for normal operation indicated by heavy dashed lines. Collecting signal data on these parameters can be useful in determining how the parameters correlate with the occurrence of defects.

A type of defect that may occur as a result of such interruption, introduction, or other disruption in the WAAM process is pores. Accordingly, argon is typically used as a shielding gas to block reactive gases from the area of the welding gun tip. Interrupting the flow of shielding gas can allow atmospheric gas to be entrained and introduce hydrogen bubbles to the weld. When the interruption is removed, the control system(s) of the welder system typically seeks stability by attempting to return to equilibrium of welding parameters in maintaining a proper weld. The interruption can be seen visually as a change in the brightness and character of the light created from welding and can be seen in the data as changes in voltage and current at the welding tip. Observation of the light of the welding can be captured by a high-speed video camera. In some embodiments of the invention, RT images may be captured in real-time during WAAM. Voltage and current can be obtained from the welder system by a signals data storage system (which can include an oscilloscope) and written to a data stream. By timestamping the video of the weld and the datastream of voltage and current, the emergence of pores can be correlated to the video and/or the voltage and current at the time the pores were created.

Porosity can represent a significant risk to the structure of an article, because porosity can degrade ultimate strength and ductility and contribute to crack propagation at places of severe porosity. Still, many examples exist of parts that remain useable despite porosity. Additionally increasing stiffness of a part via thickness can compensate for weakness due to porosity.

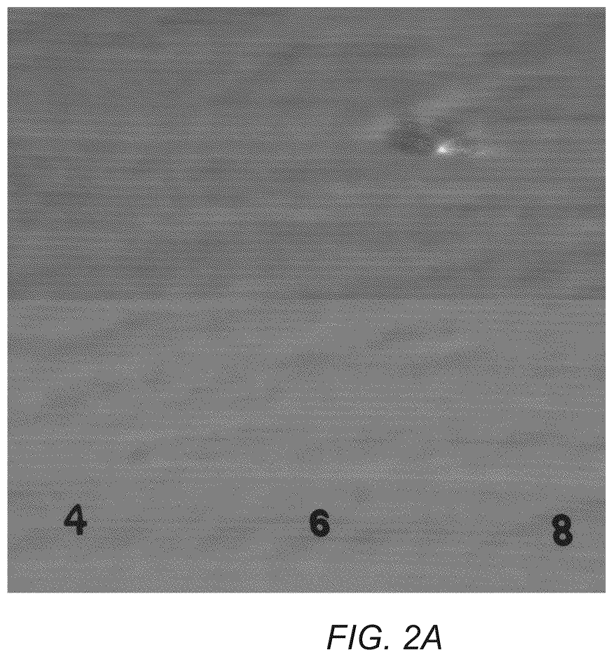

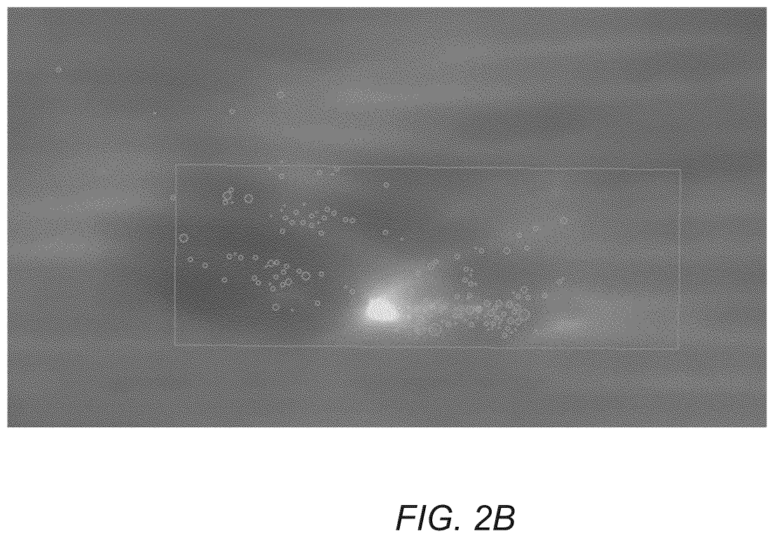

Detection and measurement of porosity groups can be important to the overall evaluation of the structure. Pores and other defects can be detected within a metal structure using radiographic testing (RT) identification processes that involve performing RT imaging using x-rays or gamma rays as a form of nondestructive evaluation (NDE). An example RT image with a pore in the upper right quadrant is shown in FIG. 2A. An enlarged portion of the RT image is shown in FIG. 2B. The locations of pores and other defects identified in the two-dimensional RT images can then be translated into the robot's three-dimensional coordinate system. These translated coordinates are then used to annotate, with the RT imagery, the sensor data that was being captured when the robot was in that location during printing. Precise timestamping of all data captured during the manufacturing process aids in accurately and precisely joining these disparate data sources for further analysis or other purposes.

### Systems for Defect Introduction

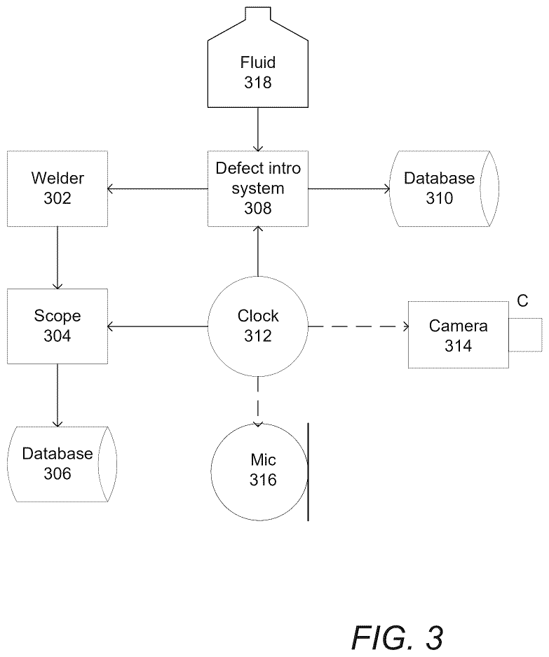

An additive system can include a defect introduction system to deliberately cause defects in the manufactured article. An additive system in accordance with embodiments of the invention is conceptually illustrated in FIG. 3. The system includes a welder system 302, a signals data storage system (e.g., an oscilloscope) 304, a defect introduction (or attack) system 308, a GPS clock 312, one or more databases 306 and 310, and a camera 314.

The welder system 302 may include an energy source, a wire feeder system, a gas source, and a welding gun. The energy source can supply power to the welding gun. The wire feeder can supply metal wire to the welding gun. The gas source can provide a shielding gas (e.g., argon) to the tip of the welding gun. In other embodiments, the welder system 302 may include a feedstock feeder system, a gas source, and a welding gun. The feedstock feeder can supply an additive feedstock to the welding gun. The gas source can provide an accelerating gas to the welding gun. In such other embodiments, the welder system 302 cold sprays the feedstock using the accelerating gas.

The signals data storage system 304 can acquire and log the voltage and current of the welding gun as it operates. The voltage and current values may be associated with timestamps for the times at which they were captured and stored in a database 306. In many embodiments of the invention, the signals data storage system includes a high frequency oscilloscope that can be used for measurements to a millisecond precision, although other intervals may be used.

The defect introduction system 308 can take action to cause defects when given commands. It may accept the same clock signal 312 as the signals data storage system 304 to synchronize timestamps. The action can be to expel a burst of air at the shielding gas column or to interrupt the flow of the shielding gas. Alternatively, a liquid, such as water, can be introduced to interrupt the flow of shielding gas. Further, the action can be to expel a burst of air at the accelerating gas or to interrupt the flow of the accelerating gas. Further still, the action can be to interrupt the flow of feedstock through the welding gun and/or introduce contaminants into or upon the feedstock before or after it leaves the welding gun. Further still, the action can be to interrupt the flow of energy (e.g., voltage, current, heat) through the welding gun and/or introducing additional energy (e.g., voltage, current, heat) into or upon the feedstock before or after it leaves the welding gun. Yet further still, the action can be introduce contaminants into or upon the article in advance of the welding gun. Different ways in which the defect introduction system 308 can disrupt the welding process are discussed further below.

In some embodiments of the invention, a liquid such as water can be introduced to interrupt the flow of the shielding gas (e.g. a few inches before the weld area). In further embodiments, the defect introduction system 308 includes a multi-line siphon manifold capable of managing different liquids and wash cycles. The siphon manifold can include a shared manifold, container modules, and a switching system. The container modules can support substances such as, but not limited to, air, a wash liquid (e.g., methanol or isopropanol), an analyte, and a blank. The switching system can include one or more solenoids or other mechanisms to switch between the container modules.

In several embodiments, the siphon manifold can cycle between washing, drying, and analysis. A wash cycle using wash liquid can clean the flow path. A blank run followed by air blow can clear residual liquid. Introduction of analyte may be used for measurement or application. This sequence can ensure minimal contamination between samples and better control over purity. Cleaning may utilize manual timing or approximation. In additional embodiments, a cleanliness sensor could be added to automate the wash cycle and verify when the system is clean.

The additive system may also include one or more cameras 314, which can be visible or infrared or ultraviolet spectrum. The cameras can capture images of the welding system while it is building the article (e.g., as video). As mentioned herein, changes in the light thrown off by the welding process (e.g., arcing) can indicate when defects or disruptions occur. In some embodiments of the invention, spectroscopy may be used to verify consistent chemistry, such as during low geometric defect printing. The cameras 314 may also receive a clock signal from clock 312 to timestamp images.

The additive system may also include one or more microphones 316, which can be sonic or infrasonic or ultrasonic. The microphones can capture audio of the welding system while it is building the article (e.g., as sound). As mentioned herein, changes in the audio thrown off by the welding process (e.g., arcing) can indicate when defects or disruptions occur. The microphones 316 may also receive a clock signal from clock 312 to timestamp audio.

The additive system may also include one or more fluid containers 318, which can store contaminants (i.e., analytes) and/or wash liquids (e.g., methanol, isopropanol, etc.). Defect introduction system 308 can be configured to apply a contaminant from one of fluid containers 318 as discussed herein. Further, defect introduction system 308 can be configured to wash its fluid lines using a wash liquid from another one of fluid containers 318, in preparation for later re-applying the contaminant, or for later applying a different contaminant from a different one of fluid containers 318. In this way, defect introduction system 308 can apply contaminants at different times, while washing in between applications to prevent cross-contamination.

While a specific additive system is discussed above with respect to FIG. 3, one skilled in the art will recognize that any of a variety of system designs may be utilized in accordance with embodiments of the invention as appropriate to a particular application.

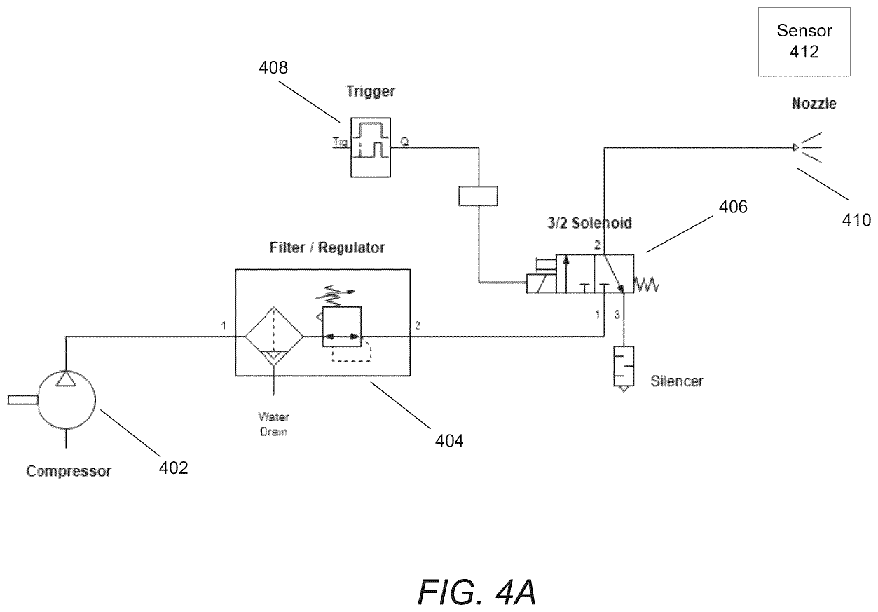

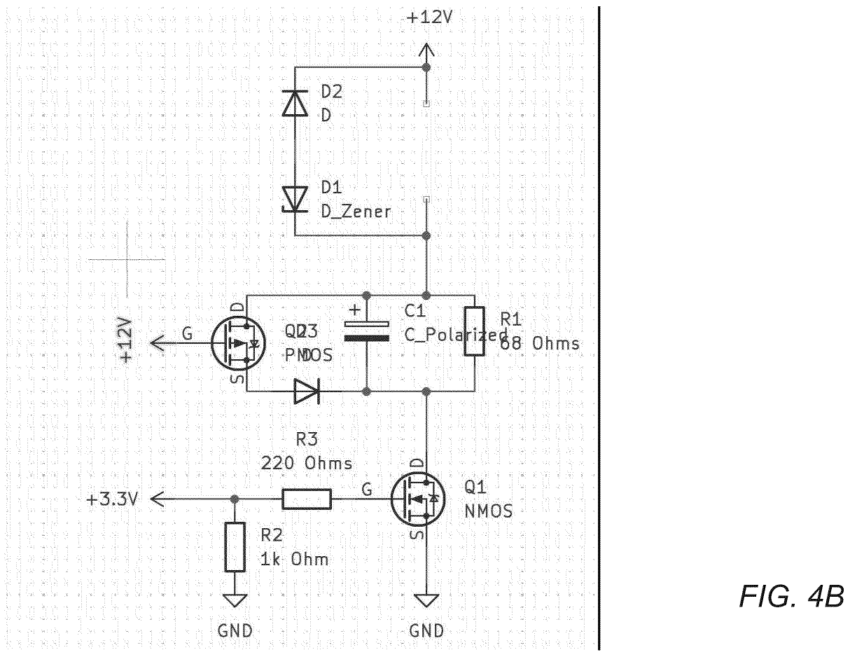

FIG. 4A illustrates a schematic for a defect introduction system 400 in accordance with some embodiments of the invention. The system includes a compressor 402, a filter/regulator 404, at least one solenoid 406, a trigger 408, a nozzle 410, a sensor 412, and a circuit 414. The compressor 402 can provide air (e.g., at 100 psi) or another gas to the filter/regulator. The filter/regulator can remove contaminants from the air to a desired level and regulate to control the amplitude of the flow of air. The trigger 408 can switch the solenoid 406 on and off to provide a path for air from the filter/regulator to the nozzle 410. Some embodiments of the invention may utilize different types (e.g., a fluidic oscillator) or numbers of nozzles.

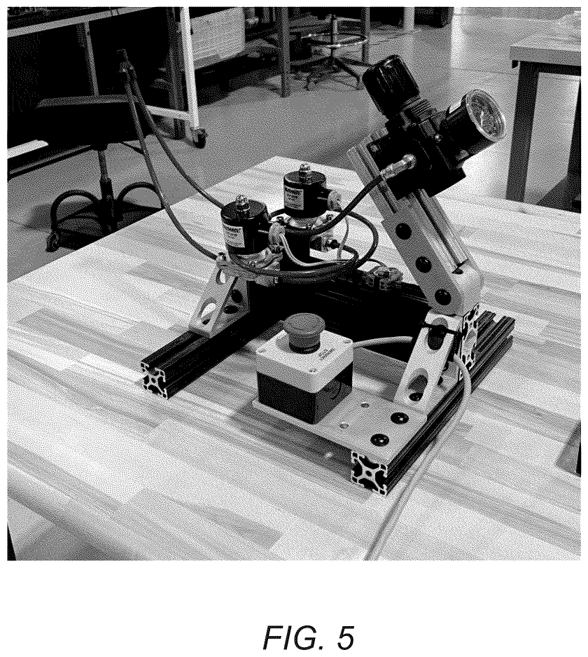

Further embodiments of the invention can include more than one solenoid. For example, two solenoids may be used in parallel and switched alternately. A circuit 414 for operating one or more solenoids in accordance with several embodiments of the invention is shown in FIG. 4B. A photo of a dual solenoid system is shown in FIG. 5. There is a limit to how fast a spring-return solenoid can close and how much time must pass before it can close again. This limits their cycle time. Placing such solenoids in parallel can allow faster cycling of the flow of air to the nozzle by allowing a second solenoid to open and close when a first solenoid cannot open and close fast enough. Alternatively, a solenoid can be electrically driven closed instead of simply allowing the spring to return.

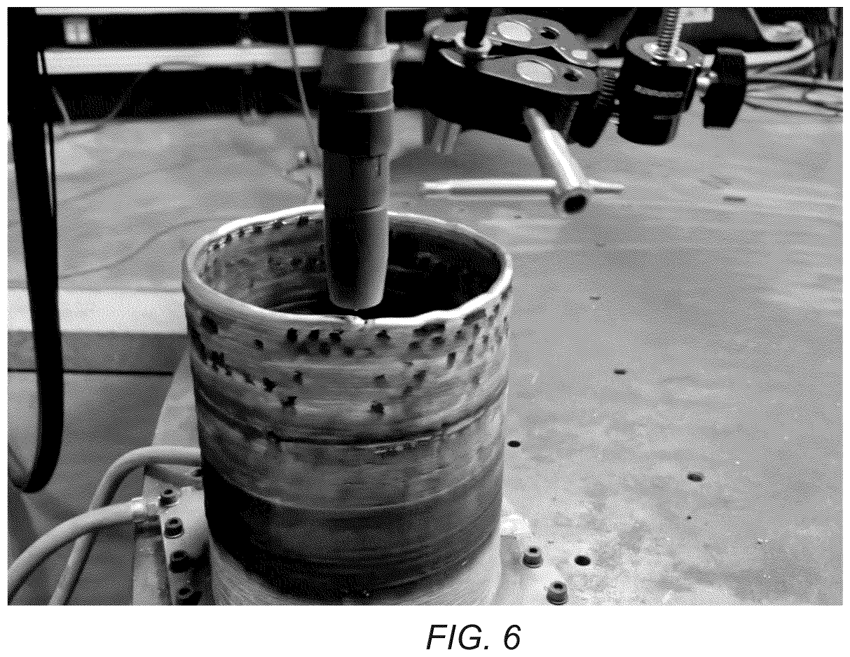

The nozzle 410 may be positioned near and/or toward the welding gun tip. A photo of a clamp holding a nozzle in accordance with an embodiment of the invention is shown in FIG. 6. In some embodiments of the invention, the nozzle and/or clamp may be fixed to the welder system so that its position relative to the welding tip is maintained. Other mechanisms and/or structures may be used to position a nozzle in accordance with embodiments of the invention. For example, a robotic arm or other movable structure may hold a nozzle. One or more sensors may detect the position of the nozzle. The position may be expressed in any of a number of ways, including in relation to the welding tip or in absolute terms. In many embodiments of the invention, the position includes axis, angle of attack, and distance from the welding tip, which can be expressed as a vector. The nozzle can be aimed, for example, using a laser. Changing the position of the nozzle can impact the collected data because the airflow will be different.

In additional embodiments of the invention, the shielding gas can be disrupted in other ways. Air or contaminants may be injected directly into the argon stream. Alternatively, instead of injecting air, the flow rate of the argon stream may be controlled. When the pressure of the argon stream is reduced, atmospheric air is allowed near the weld, which can similarly disrupt the welding process.

Further embodiments of the invention can introduce other contaminants to the shielding gas column or to the feedstock, such as, but not limited to, food particulates (proteins), hand lotion (silicone), shop oils and penetrants, or release coating on packaging. Contaminants may be injected by the Venturi effect using a vacuum system (i.e., by differential pressure) or an atomizing spray nozzle.

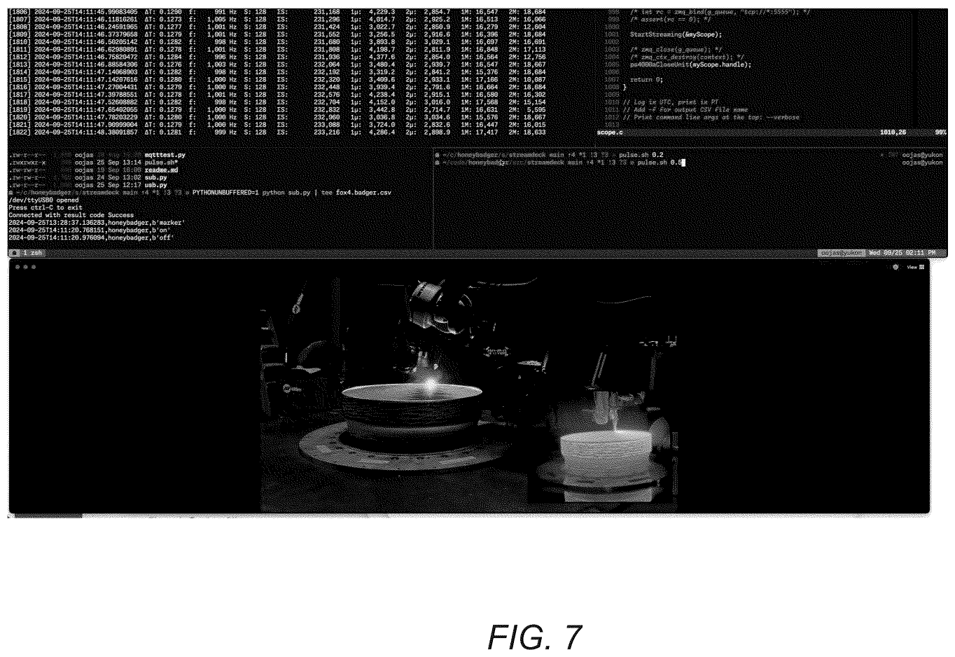

FIG. 7 shows a user interface screen in accordance with an embodiment of the invention. The text shows a start and end time of a signal given to a defect introduction system to trigger an airflow that would disrupt the welding.

While a specific defect introduction system for an additive manufactured article is discussed above with respect to FIGS. 4-6, one skilled in the art will recognize that any of a variety of systems may be utilized in accordance with embodiments of the invention as appropriate to a particular application.

### Closed Loop Control

Basic triggering of a defect introduction system (e.g., a computer signal to open a pneumatic solenoid) without feedback can be considered open loop control. There may be some deviation from the intended timing due to physical characteristics, such as the amount of time it takes the air from a defect introduction system to propagate from its source to reach the shielding gas or the feedstock, or the amount of time it takes for an interruption in shielding gas by the defect introduction system to propagate to reach the electric arc and/or weld pool, or the time it takes for affected feedstock to reach the article, and so on. The start time and/or duration of a burst of air to disrupt the shielding gas may be delayed. For example, an instruction for a pulse of 0.200 second may result in an actual pulse of 0.208 second. The length of delay can depend on any of a number of physical characteristics, such as how far the air travels to the shielding gas column after it is released and the position of the port where the air is released in relation to the shielding gas column.

Several embodiments of the invention can compensate for unintended delays by closed loop control, where the actual resulting timing can be measured and fed back to inform future instructions. As depicted in FIG. 4A, sensor 412 may be placed at the nozzle to detect changes in feedstock characteristics, or changes in pressure and/or flow of which the steady state may be a function of the diameter of the orifice of the nozzle. In many embodiments of the invention, sensor 412 can be a sensor such as, but not limited to, a feedstock temperature sensor, feedstock spectrographic sensor, hot wire anemometer or pressure gauge. Pulses of airflow may be triggered with varying characteristics, such as, time, pressure, duration, flow, etc. The timing of the measured pulse can be compared to the requested timing. Offsets can be determined for future use by the measured timings. For example, if a variable is found to have a linear relationship, a proportional derivative (PID) controller may be used to implement an offset.

When the delay offset is known or can be estimated, it can be added to the timestamp(s) that are saved for the start and end of a trigger signal. Alternatively, the actual time can be saved to the timestamp, and a delay offset can be added later during a data utilization procedure.

### Improved Construction

Instead of causing defects that would degrade the structure of an article, a defect introduction system may instead enhance the WAAM process to improve construction.

Some embodiments of the invention may use a phased array emitter to place molten droplets in desired locations in or near the weld pool by using acoustic levitation. This can create different shapes of beads that are oblong (higher and thinner). Ultrasonic tweezers may also be used to shape droplets or the weld pool.

In some cases, more pores or other types of flaws may yield improved mechanical properties due to changing the nucleation rate of the metals. The addition of active materials may also strengthen the metal such as with carbides that are stronger. Metallic foams can be created with less density in a controlled fashion, although there is typically an ideal maximum benefit from porosity.

Another purpose for introducing defects can be for marking. Defects may be placed as markers (e.g., fiducials) in specific locations in an article to locate spots on the article. Defects may also be placed for invisible watermarking, that is to embed a recognizable sequence or pattern in an article (e.g., part number or name), for traceability.

Pores or other defects may be inserted into specific areas of an article to create perforations that purposefully weaken the areas for breakage. This can provide an additional tool in manufacturing for building an intentional failure zone to fail at a certain axis. It can also be used for fragmentation control such as for flight termination systems (FTS) or munitions, e.g., to facilitate blowout panels or doors.

Moreover, different enhancements to construction can be used in different areas within the same article.

### Other Applications

The video, audio, voltage, current, and/or other sensor data may be used to train machine learning models to predict the occurrence of defects. When correlated with the actual defects that were deliberately created using accurate time synchronization, they can be taken as a labeled dataset to create a classifier. New input data provided as video, audio, voltage, current, and so on can then be run through the model to determine whether a defect may likely be present.

The dataset (or data predicted by a trained model) may also be used to create a real-time digital twin of the article in augmented reality. The digital twin may be visualized as x-ray imagery that can show locations of potential defects within the article.

### Processes for Defect Introduction

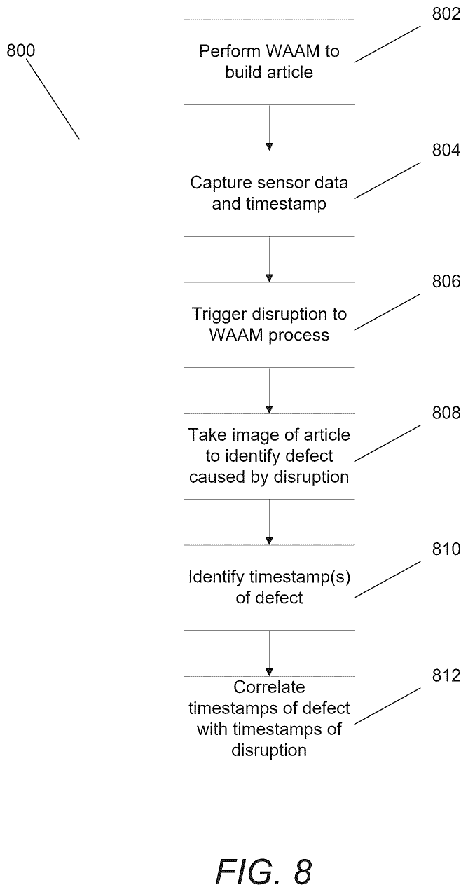

A process for intentional defect introduction in accordance with embodiments of the invention is illustrated in FIG. 8. The process 800 includes performing WAAM (802) to build at least part of an article. Sensor data are captured (804) discretely or continuously and entries are timestamped. For example, sensor data can include voltage and current data captured by a signals data storage system (which can include an oscilloscope), weld pool and surrounding area images or video captured by a camera, hot wire anemometer readings at a gas nozzle, and so on.

The process receives (806) an instruction to insert a defect, which may be scheduled or manual. Techniques for such disruptions are discussed further above. The welding gun, electric arc, and/or weld pool of the WAAM system is disturbed accordingly.

Data continues to be captured (804) from the WAAM system concerning operating parameters of the welder system. The data can be captured before, during, and after the disruption. Video of the welder system and/or article may be captured as well. In some embodiments of the invention, RT images can be captured during the weld. When RT images are captured contemporaneously, they may share a coordinate system as the robot system performing WAAM. Contemporaneous capture may help to detect defect migration, where a defect appears in one location but subsequent material deposit by WAAM causes the defect to move.

The captured data may be provided to any or all of a number of destinations in accordance with embodiments of the invention. Destinations can include a data visualization device that can display the data in graphs or other visual layouts, machine learning models that can ingest the data to train defect prediction models, and/or a database for storage.

In further embodiments of the invention, parameters describing the robot position of the WAAM system can be captured and stored in a database. The robot position parameters can be timestamped with a clock signal that is synchronized to the timestamps of the operating parameters.

Images of the article are captured (808) discretely or continuously (e.g., as video) to identify defects caused by the disruption. As mentioned above, RT images may be taken of the article contemporaneously while it is being built. RT images may also be taken after the article is built. In some embodiments of the invention, when RT images are taken after the article is built, reference markers (e.g., fiducials) can be use to index locations of the RT images to the article. In several embodiments, RT images may be taken of the article covering areas that potentially include defects to confirm that defects do appear where they were expected based on the captured video. Potential defects may be identified using information such as the position of the article and the position of the welding tip at the time the video shows changes in light thrown by the welding.

The process includes identifying timestamps (810) associated with the occurrence of defects in the article. The times can be determined by identifying defects in RT images and using position and timing information of the robot system to backtrace what times those defects were created by the welder system. With the timestamps determined, a bracket of time of interest can be identified (812) and the relevant sensor data having timestamps within that bracket. Sensor data within that bracket can be indicative of how defects occur.

Further embodiments of the invention may train machine learning models using sensor data from the times defects were created to predict whether defects are present given new sensor data in WAAM processes.

RT images may be location indexed so that the data can be fused. Using position information of the camera that took the RT images, the locations of pores and other defects identified in the two-dimensional RT images can be translated into the WAAM robot's three-dimensional coordinate system. These translated coordinates can then be used to annotate, with the RT imagery, the sensor data that was being captured when the robot was in that location during printing. Precise timestamping of all data captured during the manufacturing process aids in accurately and precisely joining these disparate data sources for further analysis or other purposes.

While a specific process for introducing defects in a WAAM manufactured article is discussed above with respect to FIG. 8, one skilled in the art will recognize that any of a variety of processes may be utilized in accordance with embodiments of the invention as appropriate to a particular application.

### Conclusion

While specific architectures, assemblies, components and/or systems for robotic additive manufacturing are described above, any of a variety of assemblies, components and/or systems can be utilized for robotic additive manufacturing as appropriate to the requirements of specific applications. Notably, all references to wire arc additive manufacturing in this application are provided as an example and should not be construed as limiting. The inventive concepts in this application are applicable to any Directed Energy Deposition (DED) 3D printing process that uses wire feedstock, any cold spray additive manufacturing process that uses powder feedstock, or any similar process that builds an article from a feedstock layer-by-layer. Relevant energy sources are plasma, arc, laser, and others. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are sometimes described in reference to robotic additive manufacturing, the techniques disclosed herein may be used in any type of robotics control system. The techniques disclosed herein may be used with any of the additive manufacturing assemblies, components, systems, methods and/or processes as described herein.

What is claimed is:

1. A robotic additive manufacturing system comprising:
an additive manufacturing robot, the additive manufacturing robot comprising:
a robotic arm;
a welder system mounted to the robotic arm and comprising a welding tip configured to deposit a consumable electrode wire onto an additively-manufactured article;
a signals data storage system configured to receive from the welder system one or more signals indicative of a voltage and a current and to store the signals as a time series;
a defect introduction system configured to receive an interrupt signal and to trigger a release mechanism configured to disrupt shielding gas around the welding tip based upon the interrupt signal; and
a clock configured to provide a clock signal to the signals data storage system and the defect introduction system.

2. The robotic additive manufacturing system of claim 1, wherein:
the defect introduction system further comprises an air compressor and a nozzle;
the release mechanism comprises at least one pneumatic solenoid;
the air compressor is configured to provide compressed air through the solenoid and to the nozzle;
the release system is configured to be triggered based upon the interrupt signal to open a path for the compressed air to the nozzle; and
the nozzle is positioned near the welding tip.

3. The robotic additive manufacturing system of claim 2, wherein the release system comprises two pneumatic solenoids that are configured to be independently and alternately actuated.

4. The robotic additive manufacturing system of claim 2, wherein the defect introduction system is configured to receive parameters indicating a position of the nozzle.

5. The robotic additive manufacturing system of claim 1, wherein the defect introduction system is configured to inject contaminants into the shielding gas.

6. The robotic additive manufacturing system of claim 1, wherein the defect introduction system is configured to determine and apply offsets to the interrupt signal when triggering the release mechanism.

7. The robotic additive manufacturing system of claim 1, wherein the signals data storage system includes an oscilloscope.

8. The robotic additive manufacturing system of claim 1, wherein:
the defect introduction system further comprises at least one liquid tank and a nozzle and is configured to release liquid from the at least one liquid tank through the nozzle based upon the interrupt signal.

9. A method for introducing defects during an additive manufacturing process, the method comprising:
capturing a data signal comprising voltage and current information while a welding system having a welding tip performs a wire arc additive manufacturing (WAAM) process to deposit metal onto an article;
capturing frames of video of the welding system while it performs the WAAM process;
associating timestamps with the voltage and current information and with frames of video as they are being captured;
receiving an interrupt signal at a defect introduction system configured to trigger a release mechanism that disrupts shielding gas around the welding tip;
triggering the release mechanism over a time duration based on the interrupt signal;
correlating at least some voltage and current information to at least some of the frames of video using the timestamps at times where the frames of video show irregularities in the WAAM process.

10. The method of claim 9, further comprising:
providing voltage and current information to train a machine learning model to determine whether defects occur based on the voltage and current information.

11. The method of claim 9, wherein the release mechanism comprises at least one pneumatic solenoid; and
where the defect introduction system further comprises an air compressor configured to provide compressed air through the solenoid and to the nozzle.

12. The method of claim 11, where the release system comprises two pneumatic solenoids in parallel that are configured to be independently and alternately actuated.

13. A method for introducing defects during an additive manufacturing process, the method comprising:
capturing a data signal comprising information about an additive manufacturing process while an additive manufacturing system deposits an additive feedstock onto an article being additively manufactured;
associating timestamps with the information about the additive manufacturing process as it is being captured;
receiving an interrupt signal at a defect introduction system configured to trigger a mechanism that disrupts the additive manufacturing process;
associating at least one timestamp with the interrupt signal;
correlating at least some of the information about the additive manufacturing process to the interrupt signal using the timestamps.

14. The method of claim 13, wherein the additive feedstock being deposited is a cold spray powder.

15. The method of claim 13, wherein the additive feedstock being deposited is a consumable electrode wire.

16. The method of claim 13, wherein the defect introduction system is configured to disrupt the additive manufacturing process by disrupting a shielding gas around the additive feedstock being deposited.

17. The method of claim 13, wherein the defect introduction system is configured to disrupt the additive manufacturing process by injecting a contaminant into a shielding gas around the additive feedstock being deposited.

18. The method of claim 13, wherein the defect introduction system is configured to disrupt the additive manufacturing process by applying a contaminant to the additive feedstock being deposited.

19. The method of claim 13, wherein the defect introduction system is configured to disrupt the additive manufacturing process by applying a contaminant to the article being additively manufactured.

20. The method of claim 13, wherein the data signal comprises at least one of voltage or current information.
